(19) United States
(12) Patent Application Publication
(10) Pub. No.: US 2007/0036453 A1
(43) Pub. Date: Feb. 15, 2007

(54) Image quality control in an imaging system

(75) Inventors: Thomas Lindquist, Eden Prairie, MN (US); William K. Preska, Woodbury, MN (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/200,363

(22) Filed: Aug. 9, 2005

(51) Int. Cl. G06K 9/40

(52) U.S. Cl. 382/254; 382/128

(57) ABSTRACT

A method of and system for controlling image quality in a digital image printing system, such as a medical image printing system, is provided a digital medical image including a set of pixels, each of which has a pixel value, is acquired from a medical image source. A medical image printer prints the medical image on media to produce a medical image print. A device measures the density of at least a subset of the set of pixels on said medical image print to produce a measured density image. There is calculated for at least the subset of the set of pixels of the digital medical image a predicted density image. The measured density image and the predicted density image are compared to produce density corrections, if any; and any density corrections are used in printing subsequent digital medical images to improve image quality thereof.

### FIELD OF THE INVENTION

This invention relates in general to imaging systems in which electronic or digital images are printed as visual images on print media and more particularly to image quality control in such imaging systems.

### BACKGROUND OF THE INVENTION

Electronic and digital imaging systems have come to permeate the imaging world. For example, medical imaging systems, such as medical image laser printers, have achieved wide acceptance in producing visual medical images on print media, such as film, from electronic or digital images acquired from medical film digitizers, from diagnostic imaging modalities (e.g., CT, MRI, PET, US), from computed and direct digital radiography, and from medical image archives. Medical image laser printers have produced medical image media which are processed either using wet processing techniques or dry thermal processing techniques.

When printing medical images, it is important to map the pixels of the original digital image into printed optical density values in a way which is accurate and reproducible. Standards defining the required accuracy of these printed densities are emerging from customers (e.g., the Mayo Clinic), professional associations (e.g., the American College of Radiology), state agencies (e. g., N.J.A.C.), and service providers.

To achieve some degree of control of absolute printed densities, medical imaging printers (also known as imagers) typically have a calibrate mode in which a special calibration test pattern is printed, (See: U.S. Pat. No. 5,481,657, issued Jan. 2, 1996 (Schubert et al). Also of interest are U.S. Pat. No. 4,757,334, issued Jul. 12, 1988, inventor Volent, and U.S. Pat. No. 4,278,347, issued Jul. 14, 1981, inventors Okamoto et al.). This calibration print may be made on request by an operator and/or automatically at certain other times, such as when a new cartridge containing unexposed film is inserted into the printer. The actual printed densities are read (sometimes by a densitometer built into the printer) and compared to expected densities and a lookup table is calculated which is used in subsequent printing to map image pixels into the desired densities.

In the course of printing many sheets of medical imaging film over a period of time (e. g., a day), it is possible that the hardware characteristics of the imager (including its film processing characteristics) may drift somewhat, making the most recent calibration no longer accurate. To address this issue, an additional feature, called a “density patch” (D-patch), was introduced (and is described in the Schubert ,et al. patent, supra, as well as in U.S. Pat. No. 6,007,971, issued Dec. 28, 1999, inventors Star et al. See also: U.S. Pat. 6,020,909, issued Feb. 1, 2000, inventors Kocher et al., U.S. Pat. No. 6,023,285, issued Feb. 8, 2000, inventors Kocher et al., and U.S. Pat. No. 6,223,585 B1, issued May 1, 2001, inventor Krogstad). The D-patch is a small constant-density patch (e. g., with a target density of about 1.0) which is printed near the leading edge or trailing edge of all the normal printed films. When the printed film exits the imager (or processor), a built in densitometer reads its density. Printer software monitors these density readings and, if they begin to drift, issues a command which adjusts the laser exposure in such a way as to correct the densities on subsequently printed films.

A problem associated with the use of a D-patch is that it is visually intrusive. Particularly for computed radiography, direct digital radiography, and mammography, radiologists would like to see the radiographic image filling the entire film, not shrunk slightly to make room for the D-patch and not locally obscured by a D-patch overlaying even a small part of the patient image. Another problem is its limitation to a few densities, rather than the full range of densities of a printed image, and its limitation dimensionally to a small area of the image print, rather than the full width and length of the image print.

There is thus a need to provide a solution to these problems.

### SUMMARY OF THE INVENTION

According to the present invention, there is provided a solution to these problems.

According to a feature of the present invention there is provided a method of controlling image quality in a digital image printing system, comprising:

acquiring a digital image including a set of pixels, each of which has a pixel value;

printing said digital image on media to produce a digital image print;

measuring the density of at least a subset of said set of pixels on said digital image print to produce a measured density image;

calculating for said subset of said set of pixels of said digital image a predicted density image;

comparing said measured density image and said predicted density image to produce density corrections, if any; and

using any said density corrections to modify software used in printing subsequent digital images to improve the image quality thereof.

According to another feature of the present invention there is provided a method of controlling image quality in a medical image printing system, comprising:

acquiring a digital medical image including a set of pixels, each of which has a pixel value;

printing said medical image on media to produce a medical image print;

measuring the density of at least said set of pixels on said medical image print to produce a measured density image;

calculating for at least said set of pixels of said digital medical image a predicted density image;

comparing said measured density image and said predicted density image to produce density corrections, if any; and

using any said density corrections to modify software used in printing subsequent digital medical images to improve the image quality thereof.

The invention has the following advantages.

1. Image quality in a medical image printing system can be accomplished without the use of a density patch so that the medical image can be printed to the edge of the print.

2. More accurate study of the medical image is possible, since the medical image has not been shrunk to make room for the density patch and is not locally obscured by a density patch overlaying even a small part of the patient's medical image.

3. More accurate, multidimensional correction is possible, since measured differences between theoretical and actual density values are not limited to a single density measurement obtained from a small patch area.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a block diagram of a medical imaging system including the present invention.

FIG. 2 is diagrammatic view illustrative of the present invention.

FIGS. 3, 4, and 5 are block diagrams of an embodiment of the method of the present invention.

FIGS. 6, 7, and 8 are graphical views useful in illustrating the embodiment of FIGS.3-5.

FIGS. 9-13 are diagrammatic views useful in illustrating the embodiment of FIGS. 3-5.

### DETAILED DESCRIPTION OF THE INVENTION

In general, according to the present invention, there is provided a solution to the problem of using a density patch on a printed medical image by using the printed medical image itself to control image quality. The solution eliminates the need to provide an area of the image media for a density patch so that the medical image can be printed to the edge of the media, or to have a portion of the printed medical image obscured by the density patch overlaying a small part of the patient medical image. Since the printer software has the entire original digital image pixel values in memory, it can compare the sequence of measured densities along the line seen by the densitometer with the theoretical (predicted) densities which those pixel values should have generated. Just as with the real density patch, deviations between theoretical and measured densities can be used to calculate adjustments to the exposure on subsequent prints. Although the following description refers to medical imaging applications, it will be understood that the invention can be used in other imaging systems, such as graphic arts imaging systems, professional photography, commercial imaging systems, and the like.

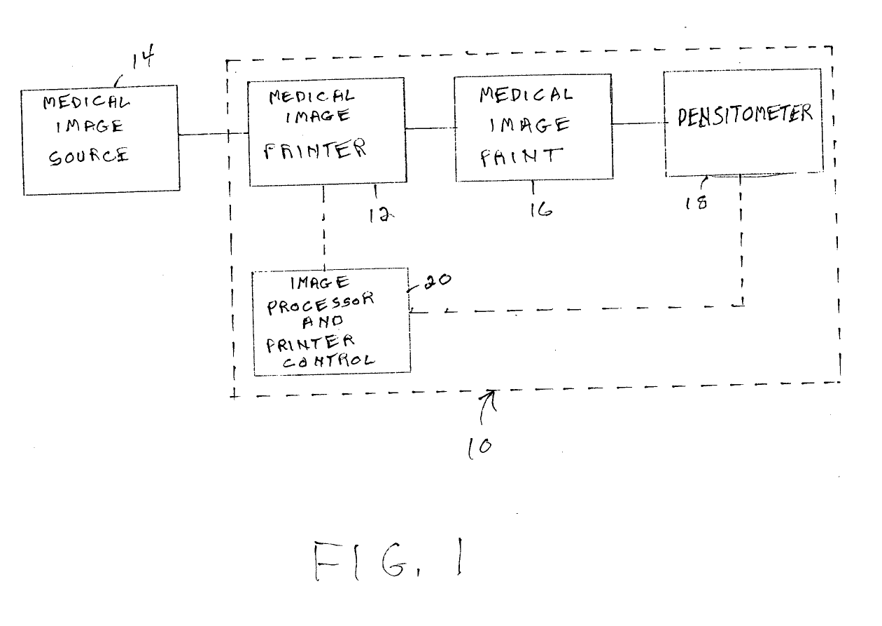

Referring now to FIG. 1, there will be described a medical imaging system incorporating the image quality control system of the present invention. As shown, medical imaging system 10 includes a medical image printer 12 which acquires an electronic or digital medical image from medical image source 14 and produces a medical image print 16 on unexposed media such as thermally processable film. According to the image quality control system of the present invention, the medical image print is scanned by densitometer 18 to produce a set of measured densities which are compared to predicted densities by image processor and printer control 20 to control the image quality of successive prints produced by system 10. It will be understood that other density measuring devices other than a densitometer can also be used.

Medical image source 14 of electronic or digital medical images can be, for example, a medical film digitizer, a diagnostic imaging modality (CT, MRI, PET, US), a computed radiography system or direct digital radiography system, or an archive of digital medical images. Medical image printer 12 can be any type printer that produces medical image prints on unexposed media that can be developed, for example by either wet chemical processing techniques or dry thermal processing techniques. An exemplary medical laser printer which produces medical images on thermally processable media is disclosed in U.S. Pat. No. 6,007,971, issued Dec. 28, 1999, inventors Star et al. As disclosed in this patent, unexposed photothermographic media is exposed to a digital medical image by means of a raster scanned diode laser. The exposed media is then thermally developed into a visual image by means of a rotating heated drum with which the media comes into contact. Other printer technologies can also be used, such as, direct thermal, electrophotographic, ink jet, thermal dye transfer, or the like. Image processor and printer control 20 controls the overall operation of system 10 and also processes the digital medical image to effect exposure of unexposed media such as by the laser diode of the Star et al. patent. Image processor and control 20 converts the raw image values of the acquired digital medical image into a sequence of digital laser drive values which are used to produce a medical image print. This process makes use of lookup tables which map the relationship between the image values and the expected optical densities of those values on the medical image print. One lookup table (sometimes called a “transfer function table) defines the user-preferred relationship between the image pixel values and the expected image media densities. (A number of transfer function tables are preferably stored so that the user can select the transfer function table which is best suited for the type of image being printed.) A second lookup table (sometimes called a “film model”) defines, based on internally measured densities on a printed calibration sheet of a given media type, the physical relationship between image media density and the laser drive value which is required to achieve that density with that media type. Typically, when a print is to be made, a final, overall lookup table is calculated by the printer by combining the user-selected transfer function table (typically adjusted to fit the density range between the media's minimum density and the user preferred maximum density) and the film model for the current media type.

Densitometer 18 typically reads an area of the printed media which is larger than a pixel area. As an example, a pixel may be about 0.039 millimeters (mm.) in diameter while the densitometer aperture is, for example, 2.5 mm. in diameter. Densitometer 18 can also be a 1-D line scanner or a 2-D area scanner (transmissive or reflective, depending on media type).

The media for medical image print 16 is preferably dry, thermally processable photothermographic film but can also be wet chemical processable film or paper, or media used with other technologies, such as, direct thermographic, ink jet, thermal transfer, or electrophotographic.

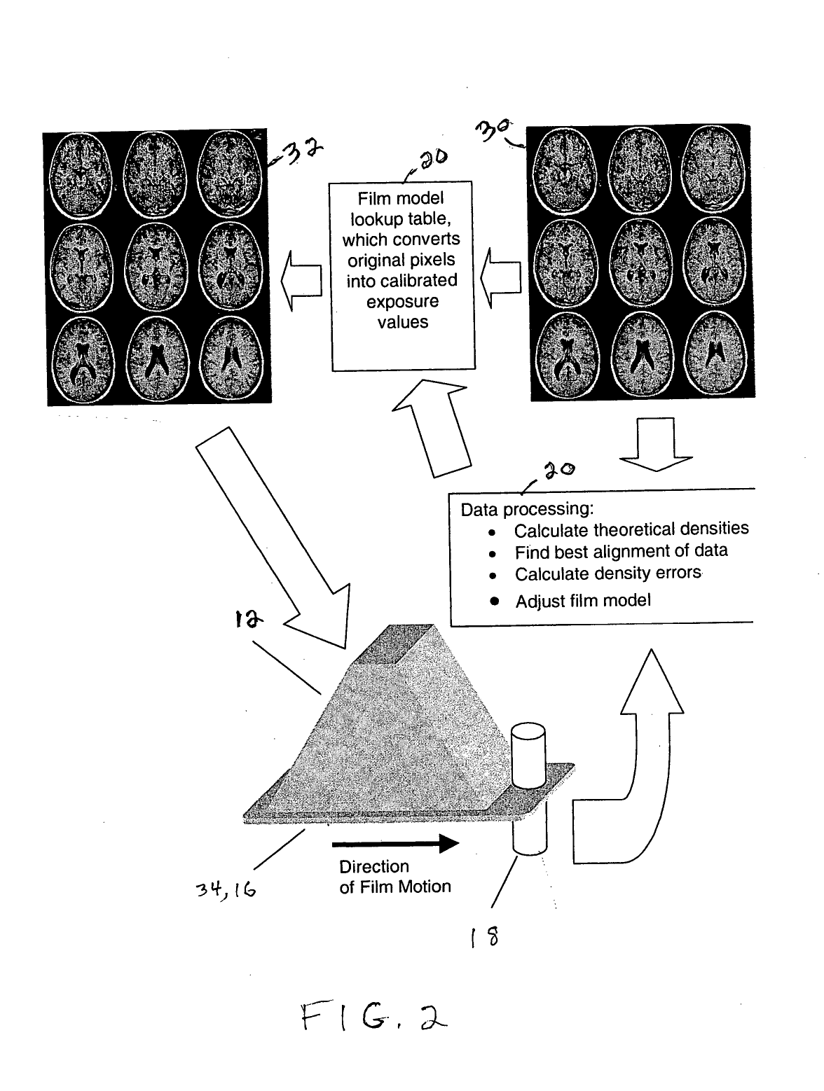

FIG. 2 is a diagrammatic view illustrative of the present invention and will be described with reference also to FIG. 1. Original digital medical image 30 is shown diagrammatically as it is acquired by system 10 from source 14. Image 30 is processed by image processor and control 20 such that the appropriate film model lookup table converts the original pixels of image 30 into calibrated exposure values at full printer resolution represented diagrammatically by final digital medical image 32. Medical image printer 12 exposes and develops media 34 to produce medical image print 16. The measured density values of medical image 16 read by densitometer 18 are then compared in processor and control 20 with predicted densities calculated from original digital medical image 30, and density errors are calculated and used to adjust the film model.

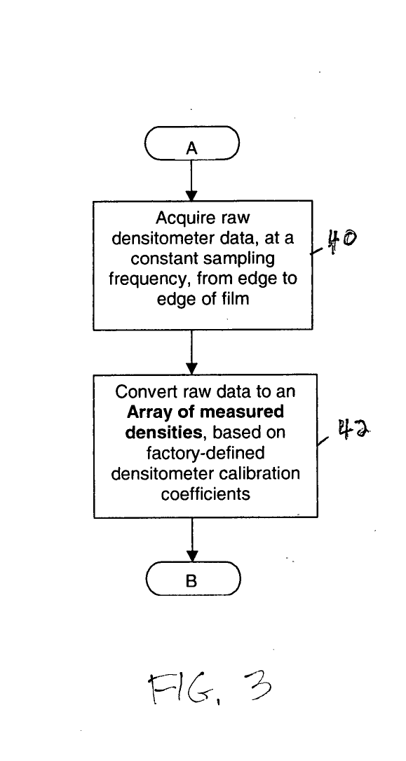

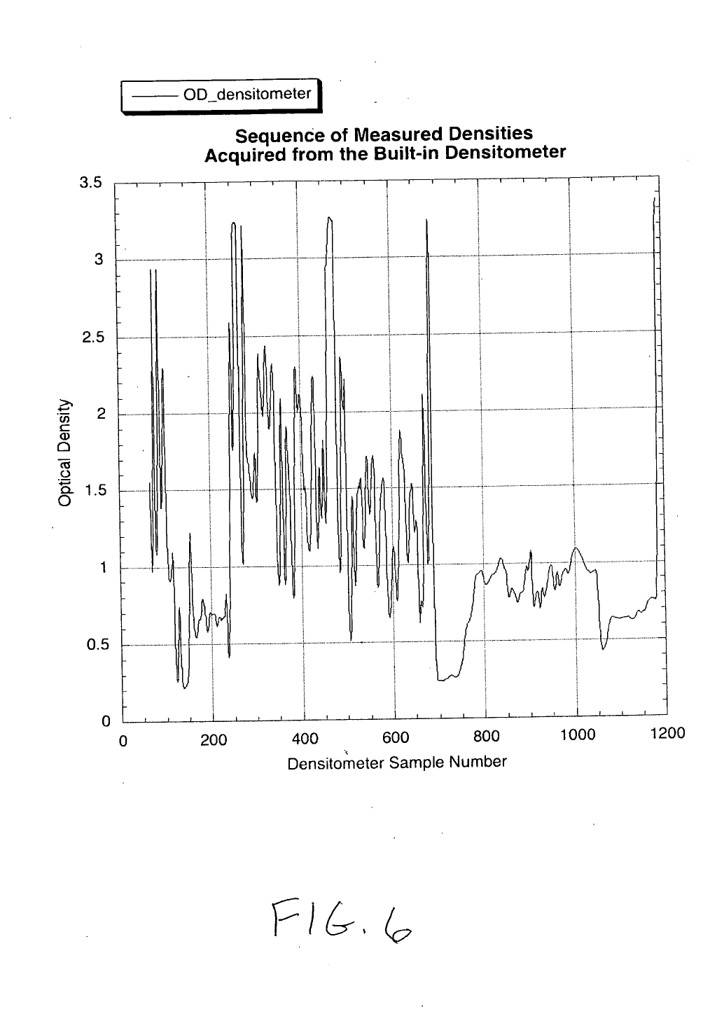

Referring now to FIGS. 3-5, there will be described an embodiment of the method of the present invention. As shown in FIG. 3, starting from “A”, the raw densitometer data is acquired by densitometer 18 at a constant sampling frequency (such as 60 Hertz), from edge to edge of medical image print 16 (box 40). Image processor and control 20 then converts the raw density data to an array of measured densities, based on factory-defined densitometer calibration coefficients (box 42). FIG. 6 is a graphical view of an array or sequence of measured densities acquired from densitometer 18 along a scan line across medical image print 16.

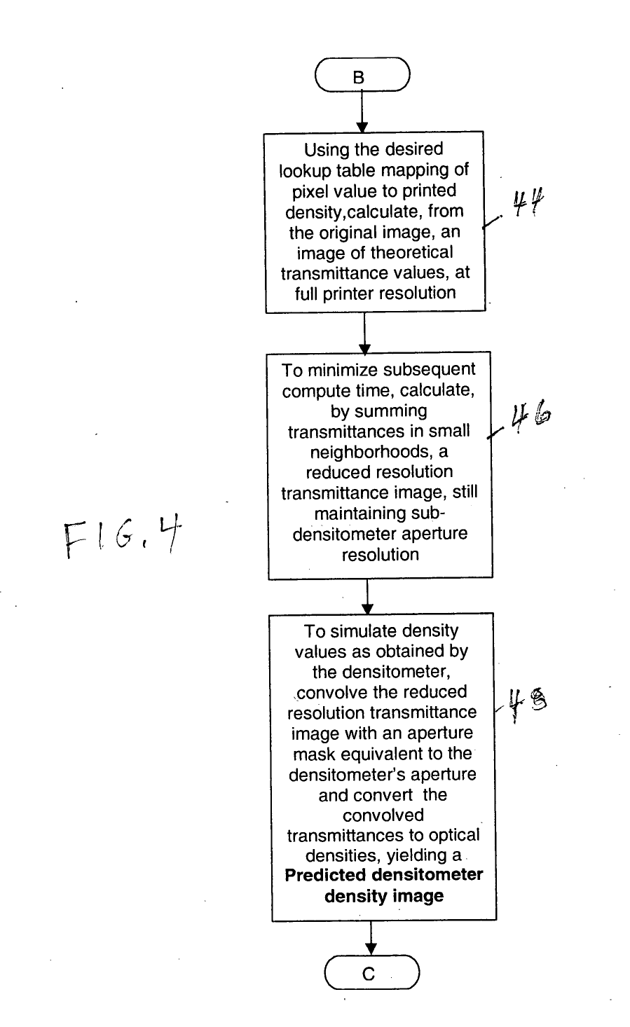

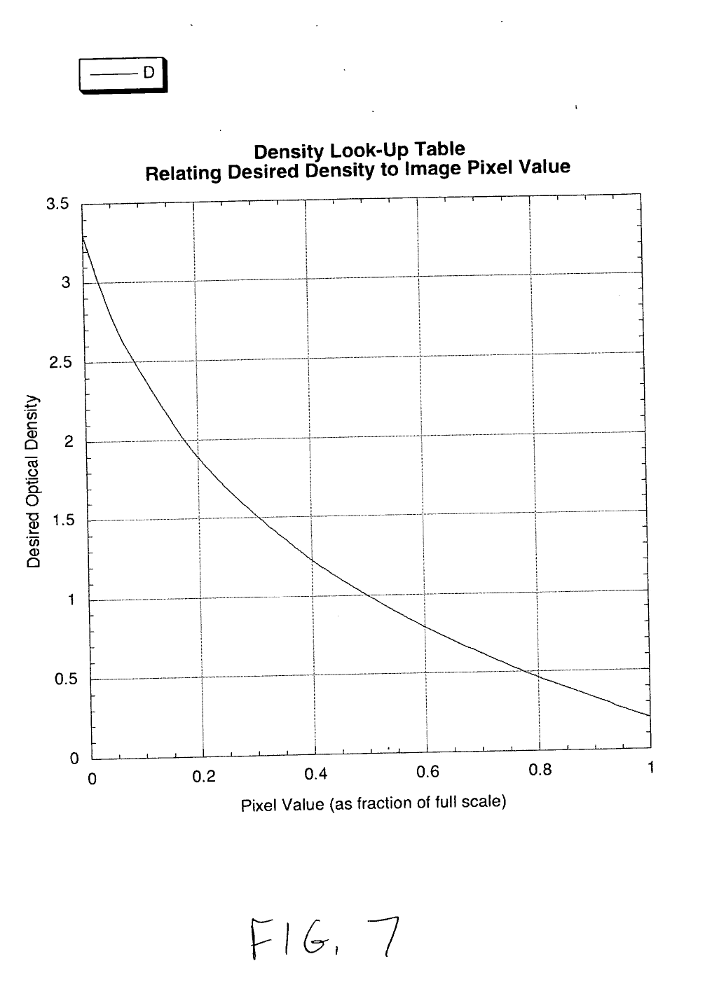

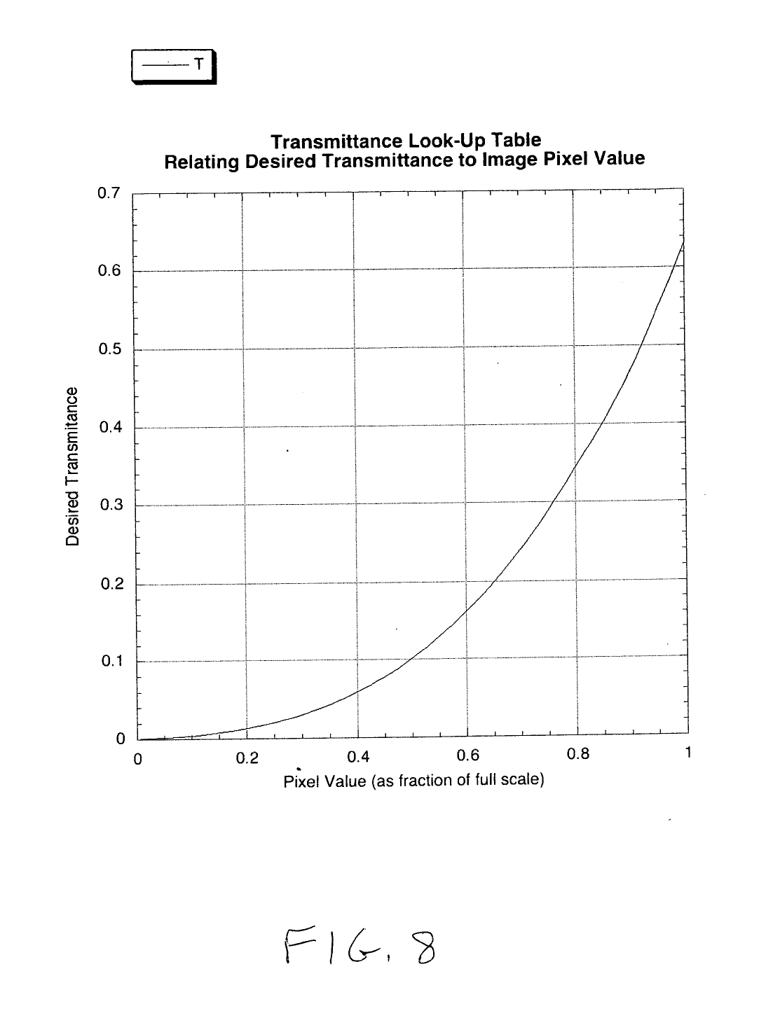

As shown in FIG. 4, starting from “B”, in box 44, using the desired lookup table mapping of pixel value to printed density values for the original digital medical image, there is calculated, from the original image, an image of theoretical transmittance values, at full printer resolution. FIG. 7 is a graphical view of Density Look-Up Table relating desired Density to Image Pixel Value and FIG. 8 is a graphical view of a Transmittance Look-Up Table relating Desired transmittance to Image Pixel Value.

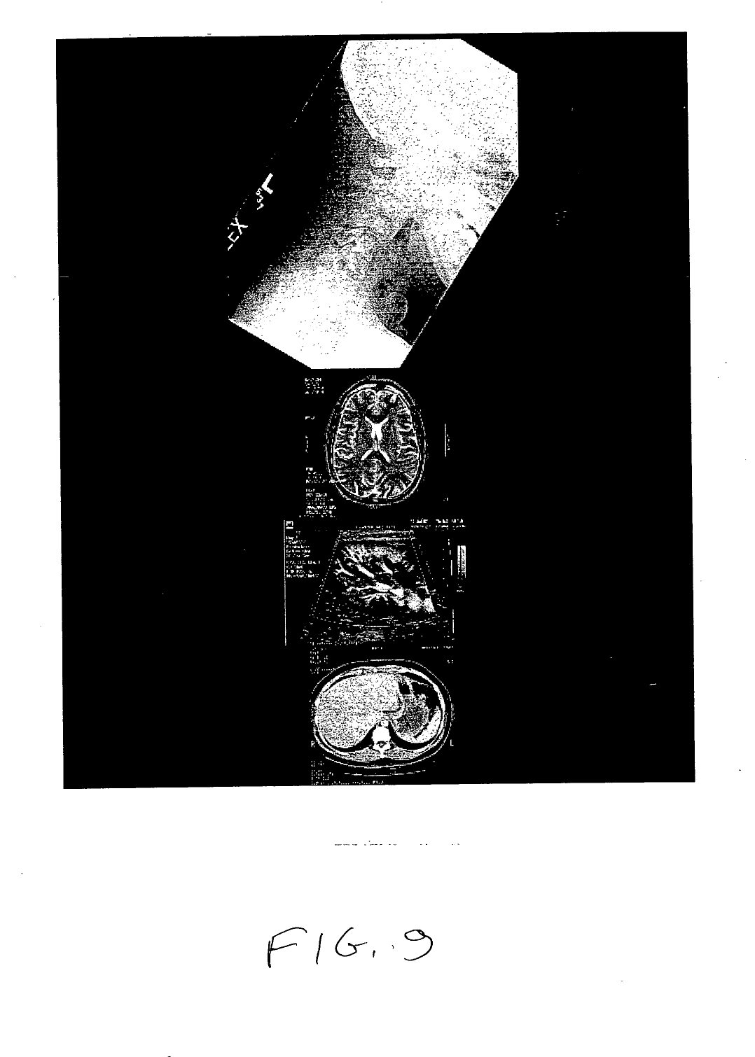

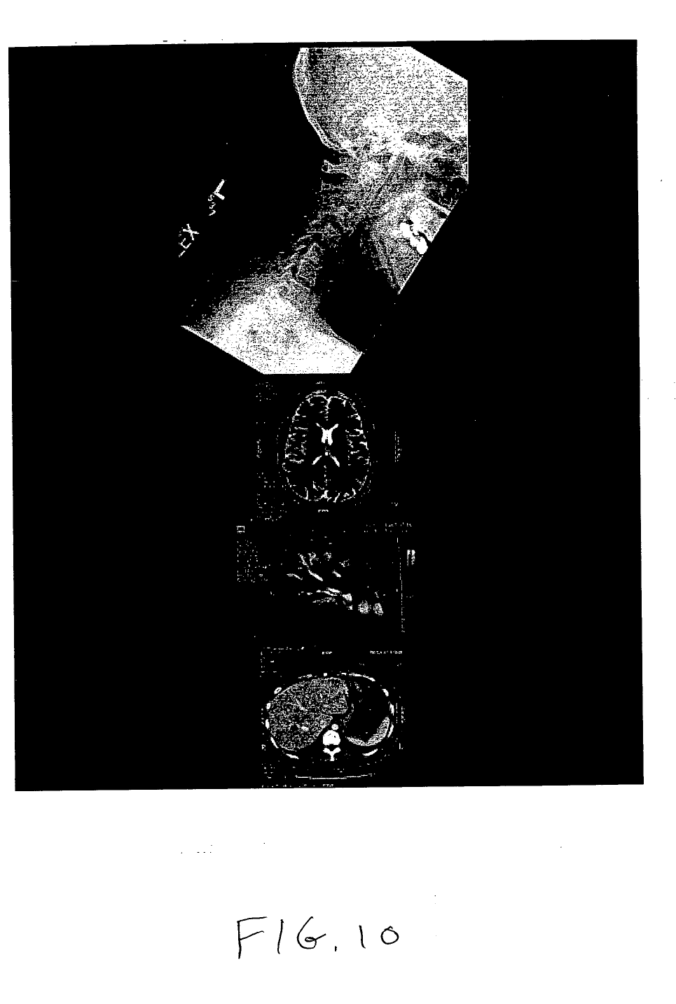

In the next step (box 46), in order to minimize subsequent compute time, there is calculated, by summing transmittances in small neighborhoods (e. g., 9×9 pixels), a reduced resolution transmittance image, still maintaining subdensitometer aperture resolution. For example, for a pixel size of 0.039 mm., the intermediate resolution image is formed of image areas of about 0.35 mm. which is still substantially smaller than the densitometer aperture of, e. g., 2.5 mm. As an example, FIG. 9 is a diagrammatic view of an original image (including a composite of images as shown), while FIG. 10 is a diagrammatic view of a reduced resolution transmittance image after conversion of the original pixels into desired transmittance values, and then averaging into a reduced resolution image (in this example, averaging 9×9 transmittance pixels into one reduced resolution transmittance pixel).

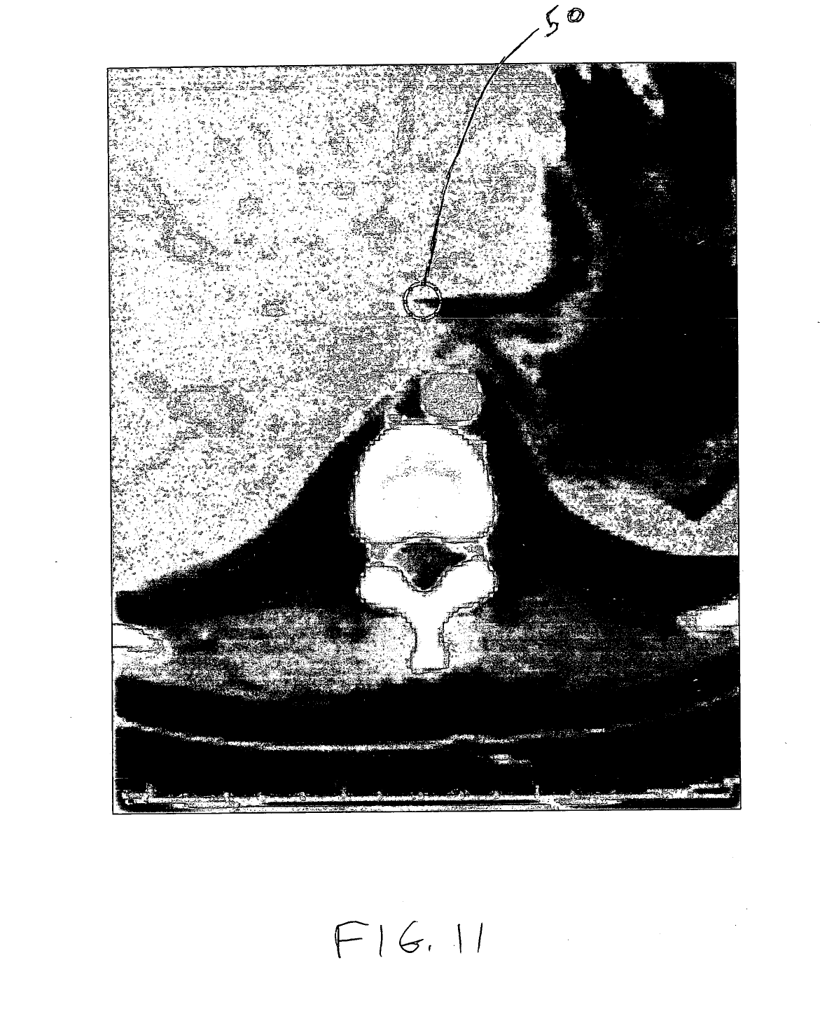

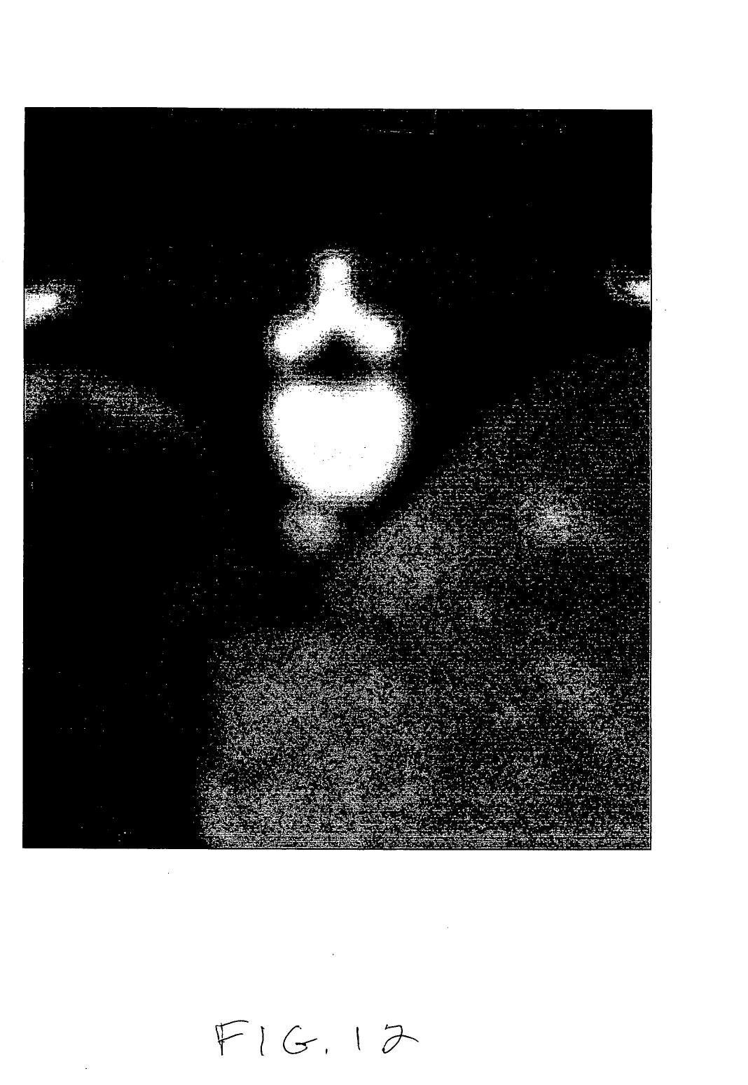

In the next step (box 48), in order to simulate the density values as obtained by the densitometer of the printed image, the reduced resolution image is convolved with an aperture mask equivalent to the densitometer's aperture and the convolved transmittances are converted to optical densities yielding a predicted densitometer density image. FIG. 11 is a diagrammatic view of an enlarged view of a portion of FIG. 10 overlaid with a circle 50 that illustrates the densitometer aperture. FIG. 12 is a diagrammatic view showing the enlarged image of FIG. 11, as a resultant blurred image after convolution with the aperture of the densitometer.

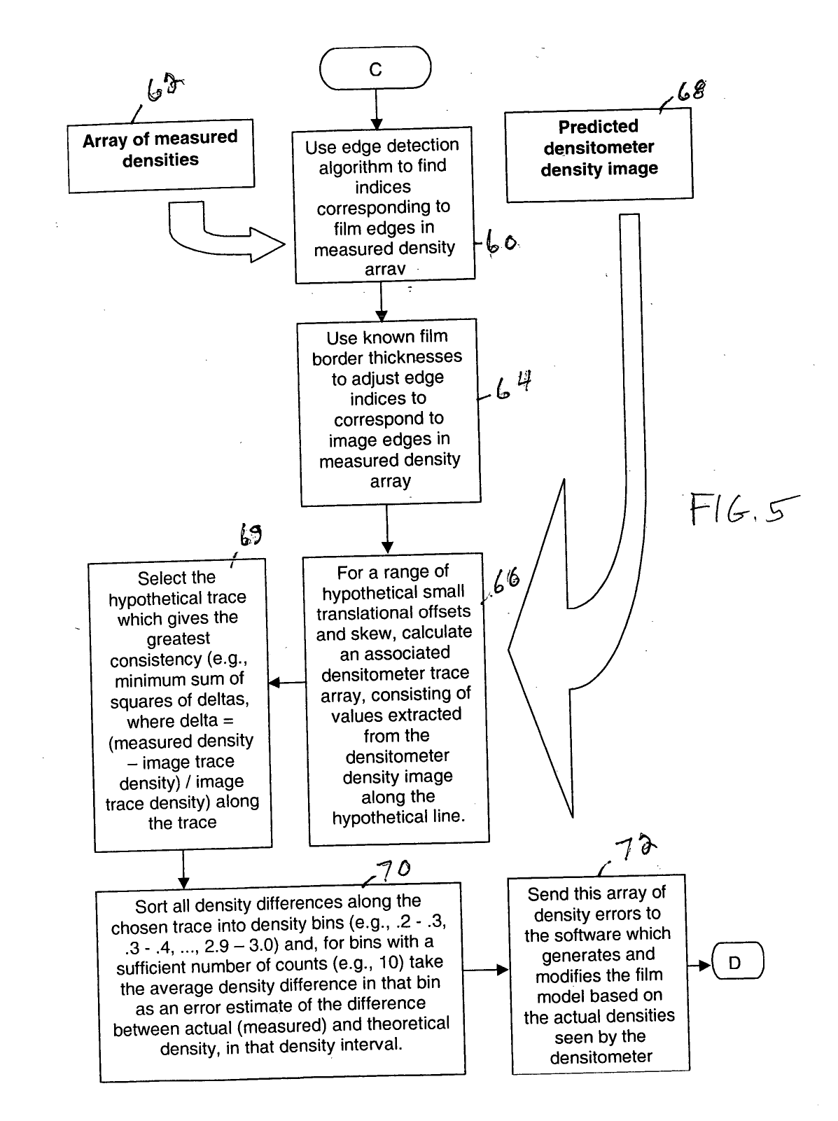

Referring now to FIG. 5, in the next step (box 60), an edge detection algorithm is used to find from the array of measured densities (box 62) (See: FIG. 3—box 42) indices corresponding to film edges in the measured density array. The edge detection algorithm can for example, be simple thresholding, using a density threshold value which is fixed at a value which is between “0” (for air) and the expected minimum density (Dmin) of the film. Other edge detection algorithms can be used (See: Algorithms for Image Processing and Computer Vision, by J. R. Parker, Wiley, 1996, ISBN 0471140562). Next, known film border thicknesses are used to adjust the edge indices to correspond to image edges in the measured density array (box 64).

Referring now to box 66, the next step processes the predicted densitometer density image (box 68) (See: FIG. 4—box 48) by calculating, for a range of hypothetical small translational offsets and skew, an associated densitometer trace array, including values extracted from the predicted densitometer image along hypothetical lines. Then (box 69), there is selected the hypothetical trace which gives the greatest consistency (e. g., minimum sum of squares of deltas, where delta =(measured density−image trace predicted density/image trace predicted density) along the trace line. The next step (box 70) is to sort all density differences along the chosen trace line into density bins (e. g., 0.2, 0.3, 0.4, . . . , 2.9, 3.0) and for bins with a sufficient number of counts (e., g., 10), to take the average density difference in that bin as an error estimate of the difference between actual (measured) and theoretical (predicted) density, in that density interval.

The previous process is based on the realization that in actual printing of a medical image, the media (film) will not, in general, be perfectly centered as it passes the densitometer. Accordingly a trace line calculation will need to be repeated for as many combinations of translational offset and skew as may be necessary to ensure that at least one calculated trace line is sufficiently close to the actual measured line seen by the densitometer. The calculated trace line which is in closest agreement to the measured densitometer trace line can be chosen as the simulated densitometer trace line.

At least in those parts of the densitometer trace line where the underlying image is not changing too rapidly, the difference between the actual densitometer trace line and the simulated densitometer trace line is usable to quantify the correctness of the current film model, at any density (or densities) where comparisons may be made. Since the underlying image content of the simulated trace line is exactly known, a tolerance limit for any comparison can be calculated such that a portion of the simulated trace which corresponds to very rapidly changing image content will be given an appropriately wide tolerance when compared with the corresponding portion of the measured trace line.

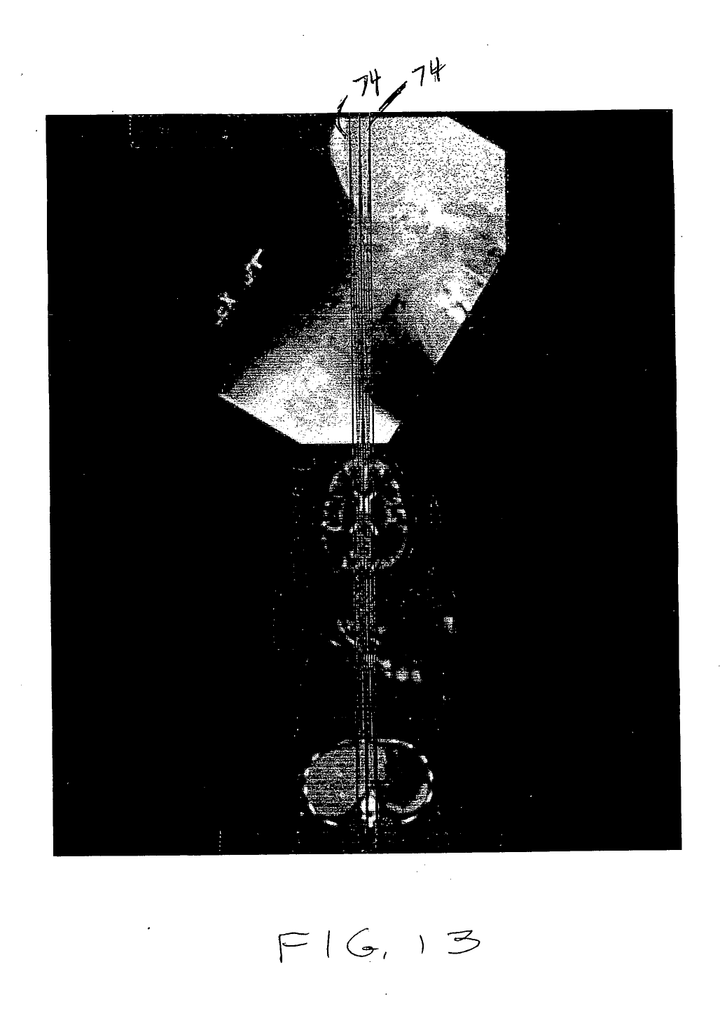

Finally, FIG. 5, box 72, the array of density errors from box 70 are processed by image processor and control 20 (FIG. 1) to generate and modify the film model based on the actual densities of the medical image print seen by the densitometer. FIG. 13 is a diagrammatic view illustrating with some exaggeration, a few of the many trace lines 74 representing possible loci of points which could be traversed by the densitometer aperture, as described above. In practice, the number of evaluated lines, defined by possible start-points and possible end-points, can be limited to the physical range which is allowed by the mechanical film placement accuracy of the printer. The density of the lines should be chosen high enough to ensure that no feature, within the resolution limit imposed by the densitometer aperture, will be missed.

As discussed above, the density detector used in carrying out the invention need not be a “point” densitometer. A 1-D receptor or a 2-D image receptor would give more complete information enabling improved feedback control.

1. A method of controlling image quality in a digital image printing system, comprising:
acquiring a digital image including a set of pixels, each of which has a pixel value;
printing said digital image on media to produce a digital image print;
measuring the density of at least a subset of said set of pixels on said digital image print to produce a measured density image;
calculating for said subset of said set of pixels of said digital image a predicted density image;
comparing said measured density image and said predicted density image to produce density corrections, if any; and
using any said density corrections to modify software used in printing subsequent digital images to improve the image quality thereof.

2. A method of controlling image quality in a medical image printing system, comprising:
acquiring a digital medical image including a set of pixels, each of which has a pixel value;
printing said medical image on media to produce a medical image print;
measuring the density of at least said set of pixels on said medical image print to produce a measured density image;
calculating for at least said set of pixels of said digital medical image a predicted density image;
comparing said measured density image and said predicted density image to produce density corrections, if any; and
using any said density corrections to modify software used in printing subsequent digital medical images to improve the image quality thereof.

3. The method of claim 2 wherein said digital medical image is acquired from one of the following medical image sources, among others, a medical film digitizer, a diagnostic imaging modality, a computed radiography system, a direct digital radiography system, an archive of digital medical images.

4. The method of claim 2 wherein said printing is carried out by means of one of a medical laser printer which produces medical image prints on thermally processable photothermographic media, an electrophotographic printer, an ink jet printer, a direct thermal printer, a thermal dye transfer printer.

5. The method of claim 3 wherein said acquired digital medical image is digitally processed by means of a media model lookup table which converts said set of pixels into calibrated exposure values which are used by said medical laser printer to produce said medical image print.

6. The method of claim 2 wherein said density measuring is carried out by one of a spot densitometer, a 1-D line receptor, and a 2-D area receptor.

7. The method of claim 2 wherein said density measuring is carried out by means of a spot densitometer having a measuring aperture of predetermined size, wherein said acquired digital medical image includes an array of pixels each of which has a pixel value, and wherein said calculating includes:
using a provided lookup table for mapping pixel value to theoretical printed densities; calculating from the acquired digital medical image, an image of theoretical transmittance values at full printer resolution; calculating, by summing transmittances in small neighborhoods, a reduced resolution transmittance image, which is smaller than the predetermined size of said densitometer aperture; convolving the reduced resolution transmittance image with an aperture mask equivalent to the densitometer's aperture; and
converting the convolved transmittances to optical densities to produce said predicted density image.

8. The method of claim 2 wherein said comparing includes: using an edge detection algorithm, finding the indices corresponding to media edges in said measured density image;
using known media border thicknesses adjusting the edge indices of said measured density image to correspond to image edges in said measured density image;
for a range of hypothetical small translational offsets and skew, calculating an associated densitometer trace line array, consisting of values extracted from the predicted density image along each hypothetical line;
selecting the hypothetical trace line which gives the greatest consistency along the trace line;
sorting all density differences, between said measured density image and said predicted density image along the chosen trace line, into density bins, and, for bins with a sufficient number of counts, taking the average density difference in that bin as an error estimate of the difference between measured and predicted density, in that density interval; and
modifying the media printing software as a function of this array of density errors to control the image quality of subsequent medical image prints.

9. A system for controlling image quality in a digital image printing system, comprising:
a digital image printer for printing an acquired digital image including a set of pixels, each of which has a pixel value, on media to produce a medical image print;
a device for measuring the density of at least a subset of said set of pixels on said digital image print to produce a measured density image; and
an image processor and printer control,
which calculates for at least said subset of said set of pixels of said acquired digital image a predicted density image;
which compares said measured density image and said predicted density image to produce density corrections, if any; and
which uses any said density corrections to modify software used in printing subsequent digital images to improve the image quality thereof.

10. A system for controlling image quality in a medical image printing system, comprising:
a medical image printer for printing an acquired digital medical image including a set of pixels, each of which has a pixel value on media to produce a medical image print;
a device for measuring the density of at least said set of pixels on said medical image print to produce a measured density image; and
an image processor and printer control,
which calculates for at least said set of pixels of said acquired digital medical image a predicted density image;
which compares said measured density image and said predicted density image to produce density corrections, if any; and
which uses any said density corrections to modify software used in printing subsequent digital medical images to improve the image quality thereof.

11. The system of claim 10 wherein said digital medical image is acquired from one of the following medical image sources, among others, a medical film digitizer, a diagnostic imaging modality, a computed radiography system, a direct digital radiography system, an archive of digital medical images.

12. The system of claim 10 wherein said medical image printer is one of a medical laser printer which produces medical image prints on thermally processable photothermographic media, an electrophotographic printer, a direct thermal printer, an inkjet printer, a thermal dye transfer printer.

13. The system of claim 12 wherein said image processor and printer control processes said acquired digital medical image by means of a media model lookup table which converts said set of pixels into calibrated exposure values which are used by said medical laser printer to produce said medical image print.

14. The system of claim 10 wherein said density measuring device is one of a spot densitometer, a 1-D line receptor, and a 2-D area receptor.

15. The system of claim 10 wherein said density measuring device is a spot densitometer having a measuring aperture of predetermined size, wherein said acquired digital medical image includes an array of pixels each of which has a pixel value, and wherein said calculating of said image processor and printer control includes:
using a provided lookup table for mapping pixel value to theoretical printed densities;
calculating from the acquired digital medical image, an image of theoretical transmittance values at full printer resolution;
calculating by summing transmittances in small neighborhoods a reduced resolution transmittance image, which is smaller than the predetermined size of said densitometer aperture;
convolving the reduced resolution transmittance image with an aperture mask equivalent to the densitometer's aperture; and converting the convolved transmittances to optical densities to produce said predicted density image.

16. The system of claim 10 wherein said comparing of said image processor and printer control includes:
using an edge detection algorithm, finding the indices corresponding to media edges in said measured density image;
using known media border thicknesses adjusting the edge indices of said measured density image to correspond to image edges in said measured density image;
for a range of hypothetical small translational offsets and skew, calculating an associated densitometer trace line array, consisting of values extracted from the predicted density image along each hypothetical line;
selecting the hypothetical trace line which gives the greatest consistency along the trace line;
sorting all density differences, between said measured density image and said predicted density image along the chosen trace line, into density bins, and, for bins with a sufficient number of counts, take the average density difference in that bin as an error estimate of the difference between measured and predicted density, in that density interval; and
modifying the media printing software as a function of this array of density errors to control the image quality of subsequent medical image prints.
